(19) United States
(12) Patent Application Publication
(10) Pub. No.: US 2026/0074813 A1
(43) Pub. Date: Mar. 12, 2026

(54) METHOD AND APPARATUS FOR GENERATING 3D SIGNAL QUALITY MAP

(71) Applicant: ELECTRONICS AND TELECOMMUNICATIONS RESEARCH INSTITUTE, Daejeon (KR)

(72) Inventors: Kun Seok KANG, Daejeon (KR); Dae Ho Kim, Gongju-si (KR)

(21) Appl. No.: 19/310,062

(22) Filed: Aug. 26, 2025

(30) Foreign Application Priority Data
Sep. 6, 2024 (KR) 10-2024-0121696

(51) Int. Cl. H04B 17/391; H04B 17/318

(52) U.S. Cl. CPC H04B 17/391; H04B 17/318

(57) ABSTRACT

The disclosure relates to a method and an apparatus for generating a 3D signal quality map. According to an aspect of the disclosure, there is provided a method for generating a 3D signal quality map, performed by a computing device including at least one processor, the method including: initializing a signal quality map; collecting signal quality values from a plurality of points; estimating a map quality state using the collected signal quality values; determining a quality map parameter based on the estimated map quality state; and updating the signal quality map using the quality map parameter.

### CROSS-REFERENCE TO RELATED APPLICATION

The present application claims priority to Korean Patent Application No. 10-2024-0121696, filed on September 6, 2024 in the Korea Intellectual Property Office, the entire contents of which are incorporated herein by reference.

### TECHNICAL FIELD

The present disclosure relates to a method and an apparatus for generating a 3D signal quality map.

### BACKGROUND

The statements in this section merely provide background information related to the present disclosure and do not necessarily constitute prior art.

Unmanned Aircraft System (UAS) refers to a system that includes an aircraft that is remotely piloted or autonomously flying.

The UTM (UAS Traffic Management) system provides real-time information to those associated with the unmanned aircraft system by the service provider UAS Service Suppliers (USS). UTM systems also communicate with a drone operator in a variety of areas, including airspace permits, UAS identification, real-time aircraft tracking, dispute advisory, and Geofence settings. The UTM system including the USS provides a 3D signal quality map of the airspace to the drone operator, and may be utilized in a route setting process of the drone and the like. After setting the flight path using the 3D signal quality map, the drone operator may check the signal quality on the path, or avoid a region where the signal is weak, and the like. Therefore, providing a 3D signal quality map of excellent quality is an important service element for attracting subscribers from the perspective of a USS operator.

### SUMMARY

An object of the present disclosure is to provide a method and apparatus for generating 3D signal quality map.

More specifically, the object of the present disclosure is to generate and continuously update, using a UTM system, a 3D signal quality map that should be provided to a drone operator for providing high-quality services such as drone route generation and service quality confirmation.

The technical objects of the present disclosure are not limited to those described above, and other technical objects not mentioned above may be understood clearly by those skilled in the art from the descriptions given below.

An embodiment of the present disclosure provides a method for generating a 3D signal quality map, performed by a computing device including at least one processor, the method including: initializing a signal quality map; collecting signal quality values from a plurality of points; estimating a map quality state using the collected signal quality values; determining a quality map parameter based on the estimated map quality state; and updating the signal quality map using the quality map parameter.

Another embodiment of the present disclosure provides an apparatus including: at least one memory; and at least one processor, wherein the at least one processor is configured to execute instructions to: initialize a signal quality map; and collect signal quality values from a plurality of points; and estimate a map quality state using the collected signal quality values; determine a quality map parameter based on the estimated map quality state; update a signal quality map using the quality map parameter.

According to the embodiment of the disclosure, by generating and updating a 3D signal quality map, the current signal quality state of the airspace may be visually provided to drone operators utilizing a UTM system, thereby contributing to safe operation of the drone, such as setting a route of the drone.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a schematic block diagram of an apparatus for generating a 3D signal quality map according to an embodiment of the disclosure.

FIG. 2 is a diagram illustrating display of a 3D signal quality map according to an embodiment of the disclosure.

FIG. 3 is a diagram illustrating a 3D signal quality value according to an embodiment of the disclosure.

FIGS. 4A and 4B are each a diagram illustrating update results according to interpolation depth of a 3D signal quality map according to an embodiment of the disclosure.

FIG. 5 is a diagram illustrating a possibility of updating a signal quality map by iteration according to an embodiment of the disclosure.

FIG. 6 is a flowchart illustrating a process of generating and updating a 3D signal quality map according to an embodiment of the disclosure.

FIG. 7 is a block diagram schematically illustrating an example computing device that may be used to implement a method or apparatus according to the disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

The disclosure relates to a method and an apparatus for generating a 3D signal quality map.

Using the UTM system, drone operators are provided with services related to drone operation, such as establishing flight plans and permission of drones. In the course of a drone's flight, it is important for the drone operator to be provided with stable communication. Therefore, the USS system should provide the 3D signal quality map service of the airspace, which may be utilized by the drone operator for establishing flight plans and the like. Herein, the 3D signal quality map means a map that visually represents signal quality at various altitudes. The 3D signal quality map may be provided in a form in which a signal quality value is matched to a position defined by latitude, longitude, and altitude.

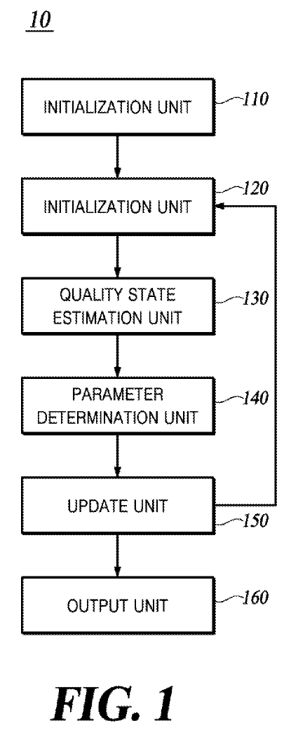

FIG. 1 is a schematic block diagram of an apparatus 10 for generating a 3D signal quality map according to an embodiment of the disclosure.

The 3D signal quality map generation device 10 (hereinafter referred to as “signal quality map generation device”) may include all or part of an initialization unit 110, a data collection unit 120, a quality state estimation unit 130, a parameter determination unit 140, an update unit 150, and an output unit 160. The components shown in FIG. 1 represent functionally distinct elements, and may be implemented in a form in which at least one component is integrated with one another in an actual physical environment.

The initialization unit 110 initializes all signal quality values of the region to be shown on the map. The initialized signal quality value, i.e., the initial value Qinit, may be any arbitrary value such as an average value or a median value of currently collected signal quality values.

The data collection unit 120 may collect the signal quality value by the number of units Nm used for generating and updating the signal quality map. The number of units indicates the number of data points to be measured. For example, if the number of units Nm is 100, 100 signal quality values should be collected to update or generate the signal quality map. The collection of signal quality values is performed continuously.

The quality state estimation unit 130 may estimate the current map quality state using the data collected from the data collection unit 120. The estimation of the current map quality state uses a mean square error (MSE) between the collected signal quality values and the corresponding signal quality map values at the same positions. It may be determined that the larger the MSE, the larger the error of the current signal quality map. That is, it may be determined that the higher the MSE, the lower the accuracy of the signal quality map.

The parameter determination unit 140 determines the quality map parameter based on the quality state estimation value. The quality map parameter includes interpolation depth Dintp and iteration Iiter. The interpolation depth Dintp refers to a range in which interpolation is applied when the signal quality map is updated based on the collected signal quality value. The iteration Iiter refers to a process of sequentially performing the update for the number of units corresponding to the collected signal quality value and the signal quality map state value, and then repeating the same again. In the process of determining the quality map parameter, if the quality state estimation value, i.e., the MSE is large, the signal quality error is large, so the interpolation depth and the number of iterations are set to be large, and the smaller the error, the lower the interpolation height and the number of the iterations are applied. In the process of determining the parameter, a distance between indices of latitude, longitude, and altitude, i.e., a distance of a signal quality map output unit, should be considered and determined.

The update unit 150 generates new values by the interpolation depth in both positive and negative directions of latitude, longitude, and altitude, based on the position of the collected signal quality values. The update unit 150 may perform initial generation and update of the 3D signal quality map by continuously performing update by dividing the continuously collected signal quality values by the number of units used for update.

The output unit 160 visually displays a signal quality map and provides the map to the drone operator. The drone operator may look at the map and establish a flight plan. The collected signal quality values are reflected in the map in real time, so that the output unit 160 may provide the signal quality information in the latest state.

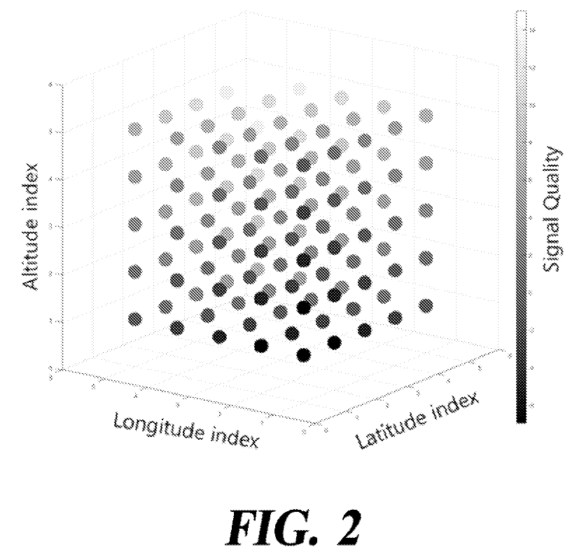

FIG. 2 is a diagram illustrating display of a 3D signal quality map according to an embodiment of the disclosure.

The signal quality map may be displayed at a position in the form of a voxel or a sphere having a corresponding color in a color map corresponding to the signal quality values. The voxel means a pixel in the 3D space, and is in the form of a small cube representing a signal quality value at each position. For example, the map is divided into x, y, and z axes, and each voxel reflects the signal quality value at a specific position. The spherical shape may visually represent the signal quality values of each position in a smoother manner.

When the drone operator establishes a flight plan, the drone operator may select a communication-stable route by referring to the 3D signal quality map. In addition, during flight, the operator may receive an updated signal quality map in real time to monitor the communication state. Therefore, in the event of an unexpected signal degradation, the operator may respond immediately.

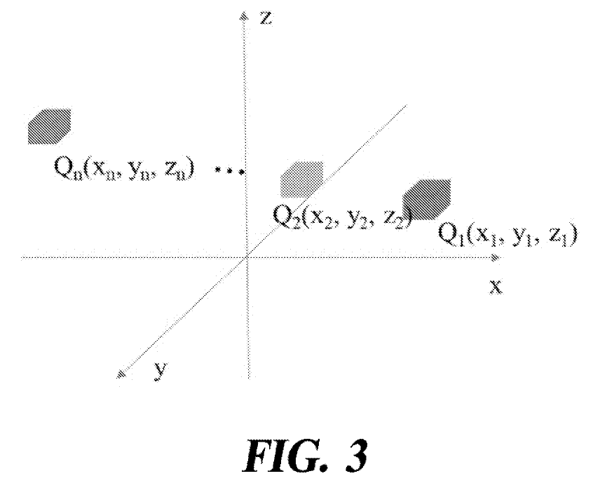

FIG. 3 is a diagram illustrating a 3D signal quality value according to an embodiment of the disclosure.

The 3D signal quality values in FIG. 3 are displayed in the form of voxels. The 3D space is divided into small cubes, and each voxel is displayed with a color corresponding to the signal quality value at the corresponding position. The higher the resolution of the voxel, the more accurate the signal quality map may be produced.

UTM service providers may receive and aggregate the current signal quality status from the drone while operating the drone. The signal quality state may be received along a movement path of the drone, and may be represented by the signal quality value and position value.

In FIG. 3, the x, y, and z axes represent latitude, longitude, and altitude, respectively, and the Q values represent signal quality values at the corresponding positions.

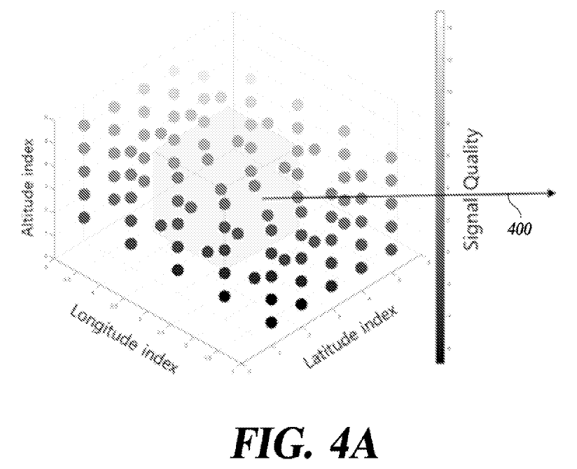

FIGS. 4A and 4B are each a diagram illustrating update results according to interpolation depth of the 3D signal quality map according to an embodiment of the disclosure. To describe FIGS. 4A and 4B, reference may be made to FIG. 1 together.

The update unit 150 performs updating based on the interpolation depth.

FIG. 4A is a diagram illustrating the 3D signal quality map. Referring to FIG. 4A, the interior 400 of the cube is currently in a state where there is no signal quality value, that is, an empty state.

FIG. 4B is a diagram illustrating an update result according to an interpolation depth when the interpolation depth is 1.

The update unit 150 generates new signal quality values by the interpolation depth in both positive and negative directions of latitude, longitude, and altitude from the position of the collected signal quality value. The update unit 150 generates a new signal quality map values by using interpolation between the collected signal quality value and signal quality map values located one unit farther than the interpolation depth. The map value of the position of the collected signal quality value in the 3D signal quality map is replaced with the collected signal quality values, and the update unit 150 generates a new signal quality map value corresponding to the determined interpolation depth. The number of new signal quality values generated according to the interpolation depth Dintp is (2* Dintp+1)³.

FIG. 4B shows a case where the interpolation depth is currently 1, and a total of 27 signal quality values are generated, including the collected signal quality value at the center.

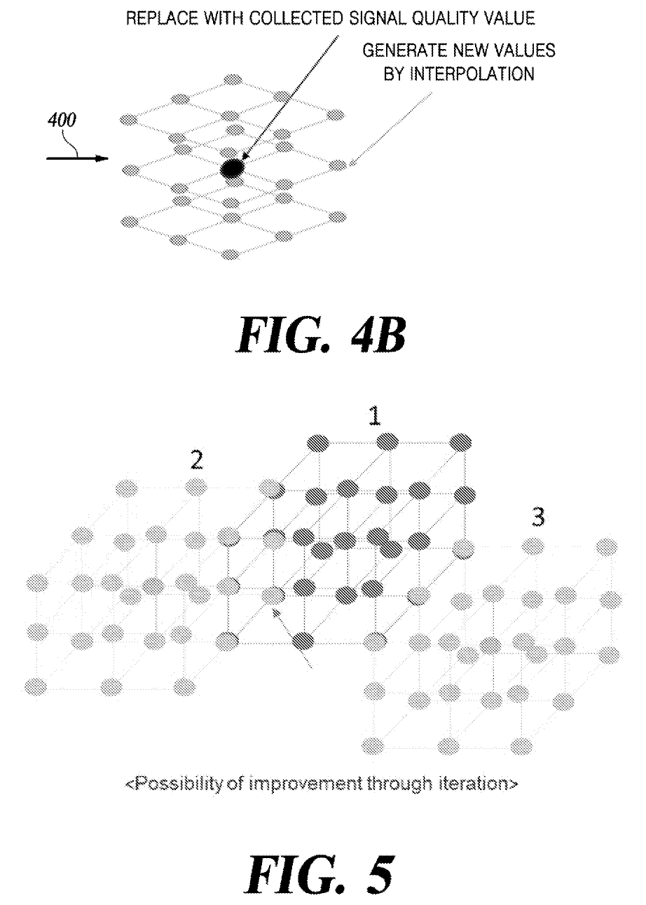

FIG. 5 is a diagram illustrating a possibility of updating a signal quality map by iteration according to an embodiment of the disclosure. To describe FIG. 5, reference may be made to FIG. 1 together.

The iteration Iiter refers to a process of sequentially performing the update for the number of units corresponding to the collected signal quality value and the signal quality map state value, and then repeating the same again. Referring to FIG. 5, when the signal quality map update is sequentially performed according to the signal quality values collected in the order of 1, 2, and 3, after the update according to the first collected signal quality value, due to the update by the second collected signal quality value and third collected signal quality value, the surrounding signal quality value of the first collected signal quality value changes, so the signal quality map updating by the first collected signal quality value is performed again, thereby improving the signal quality map.

The update unit 150 performs the updates by dividing the signal quality values continuously collected from the data collection unit 120 by the number of units used for the update. For example, assuming that the data collection unit 120 collects 10,000 signal quality values, the data collection unit does not perform updating 10,000 values at once, but performs updating continuously by dividing the updating by the number of units (e.g., 1,000). In other words, assuming that the number of units is 1,000, the updating unit 150 updates 1,000 signal quality values, and repeatedly updates the 1,000 signal quality values again, thereby updating the total number by 10,000.

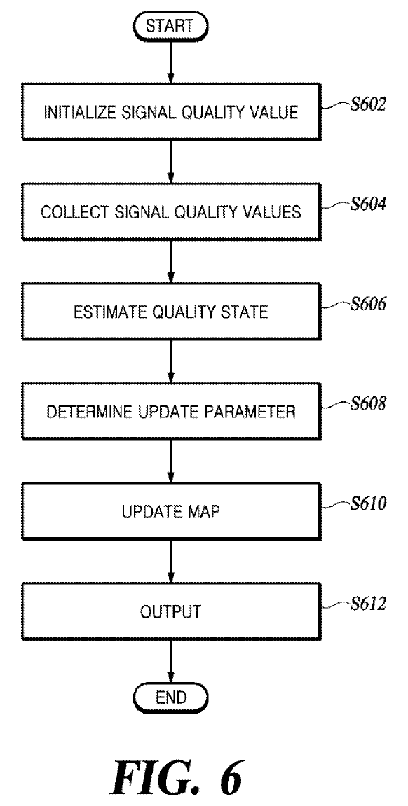

FIG. 6 is a flowchart illustrating a process of generating and updating a 3D signal quality map according to an embodiment of the disclosure.

The initialization unit 110 initializes all signal quality values in a region to be shown on the map. The initial value Qinit may be an arbitrary value such as an average value or a median value of currently collected signal quality values (S602).

The data collection unit 120 collects signal quality values from a plurality of points. The collection of signal quality values is performed continuously (S604).

The quality state estimation unit 130 estimates the current map quality state using the data collected from the data collection unit 120 (S606). The estimation of the current map quality state uses the mean square error (MSE) between the collected signal quality values and the corresponding signal quality map values at the same positions. It may be determined that the larger the MSE, the larger the error of the current signal quality map.

The parameter determination unit 140 determines the quality map parameter based on the quality state estimation value (S608). The quality map parameter includes interpolation depth Dintp and iteration Iiter. The interpolation depth Dintp refers to a range in which interpolation is applied when the signal quality map is updated based on the collected signal quality value. The iteration Iiter refers to a process of sequentially performing the update for the number of units corresponding to the collected signal quality value and the signal quality map state value, and then repeating the same again. In the process of determining the quality map parameter, if the quality state estimation value, i.e., the MSE is large, the signal quality error is large, so the interpolation depth and the number of iterations are set to be large, and the smaller the error, the lower the interpolation height and the number of the iterations are applied. In the process of determining the parameter, a distance between indices of latitude, longitude, and altitude, i.e., a distance of a signal quality map output unit, should be considered and determined.

The update unit 150 generates new signal quality values by the interpolation depth in both positive and negative directions of latitude, longitude, and altitude, based on the position of the collected signal quality values. The update unit 150 may perform initial generation and update of the 3D signal quality map by continuously performing update by dividing the continuously collected signal quality values by the number of units used for update (S610).

The output unit 160 visually displays a signal quality map and provides the map to the drone operator (S612).

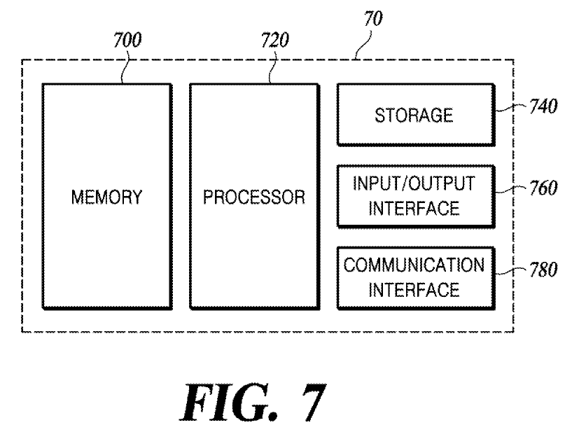

FIG. 7 is a block diagram schematically illustrating an example computing device that may be used to implement a method or apparatus according to the disclosure.

The computing device 70 may include some or all of the memory 700, the processor 720, the storage 740, the input/output interface 760, and the communication interface 780. The computing device 70 may be a stationary computing device such as a desktop computer, server, etc., as well as a mobile computing device such as laptop computer, smart phone, etc. The computing device 70 may include any specialized hardware accelerator capable of processing operations on the artificial intelligence model in an efficient manner. For example, the computing device 70 may include a graphic processing unit (GPU), a tensor processing unit (TPU), or a neural processing unit (NPU).

The memory 700 may store a program that causes the processor 720 to perform a method or an operation according to various embodiments of the disclosure. For example, the program may include a plurality of instructions executable by the processor 720, and the method or operations described above may be performed by executing the plurality of instructions by the processor 720). Memory 700 may be a single memory or a plurality of memories. In this case, information required to perform the method or operation according to various embodiments of the disclosure may be stored in a single memory or may be stored in multiple memories. When the memory 700 is composed of a plurality of memories, the plurality of memories may be physically separated. The memory 700 may include at least one of a volatile memory and a non-volatile memory. The volatile memory includes a static random access memory (SRAM), a dynamic random access memory (DRAM), and the like, and the nonvolatile memory includes a flash memory and the like.

The processor 720 may include at least one core capable of executing at least one instruction. The processor 720 may execute instructions stored in the memory 700. The processor 720 may be a single processor or a plurality of processors.

The storage 740 maintains the stored data even if power supplied to the computing device 70 is cut off. For example, the storage 740 may include a non-volatile memory and may include a storage medium such as a magnetic tape, an optical disk, or a magnetic disk. The program stored in the storage 740 may be loaded into the memory 700 before being executed by the processor 720. The storage 740 may store a file written in a program language, and a program generated by a compiler or the like from the file may be loaded into the memory 700. The storage 740 may store data to be processed by the processor 720 and/or data processed by the processor 720.

The input/output interface 760 may provide an interface with an input device such as a keyboard, mouse, or the like and/or an output device such as a display device, printer, or the like. The user may trigger execution of a program by the processor 720 via an input device and/or confirm a processing result of the processor 720 through an output device.

The communication interface 780 may provide access to an external network. The computing device 70 may communicate with other devices via communication interface 780.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for generating a 3-dimensional signal quality map, performed by a computing device comprising at least one processor, comprising:
initializing a signal quality map;
collecting signal quality values from a plurality of points;
estimating a map quality state using the collected signal quality values;
determining a quality map parameter based on the estimated map quality state; and
updating the signal quality map using the quality map parameter.

2. The method of claim 1, wherein the initial signal quality map values are average values or median values of the collected signal quality values.

3. The method of claim 1, wherein the map quality state is estimated using a mean squared error.

4. The method of claim 1, wherein the quality map parameter comprises an interpolation depth and an iteration.

5. The method of claim 4, wherein the interpolation depth is a range to which interpolation is applied when the signal quality map is updated around the collected signal quality values.

6. The method of claim 5, wherein the updating comprises generating values in both the positive and negative directions of latitude, longitude, and altitude from the position of the collected signal quality values, by an amount based on the interpolation depth.

7. The method of claim 4, wherein the iteration sequentially performs the updating by a unit number of times based on the collected signal quality values and the signal quality map state values, and repeats the updating.

8. The method of claim 1, wherein the signal quality map is represented in either a voxel form or a spherical form.

9. The method of claim 1, wherein the signal quality map is updated in real time and provided to a drone operator.

10. An apparatus comprising:
at least one memory; and
at least one processor,
wherein the at least one processor is configured to execute instructions to:
initialize a signal quality map;
collect signal quality values from a plurality of points;
estimate a map quality status using the collected signal quality values;
determine a quality map parameter based on the estimated map quality status; and
update a signal quality map using the quality map parameter.

11. The apparatus of claim 10, wherein the signal quality value is one of an average value or a median value of the collected signal quality values.

12. The apparatus of claim 10, wherein the map quality status is estimated using a mean square error.

13. The apparatus of claim 10, wherein the quality map parameter comprises an interpolation depth and an iteration.

14. The apparatus of claim 13, wherein the interpolation depth is a range to which interpolation is applied when the signal quality map is updated around the collected signal quality values.

15. The apparatus of claim 14, wherein the updating comprises generating values in both the positive and negative directions of latitude, longitude, and altitude from the position of the collected signal quality values, by an amount based on the interpolation depth.

16. The apparatus of claim 13, wherein the iteration is configured to sequentially perform the updating a unit number of times based on the collected signal quality values and the signal quality map state values, and to repeat the updating.

17. The apparatus of claim 10, wherein the signal quality map is represented in either a voxel form or a spherical form.

18. The apparatus of claim 10, wherein the signal quality map is updated in real time and provided to a drone operator.
